(19) United States
(12) Patent Application Publication
(10) Pub. No.: US 2013/0000943 A1
(43) Pub. Date: Jan. 3, 2013

(54) CENTER CONDUCTOR WITH DESIGNABLE ATTENUATION CHARACTERISTICS AND METHOD OF FORMING THEREOF

(75) Inventor: ALAN JOHN AMATO, Cheshire, CT (US)

(73) Assignee: JOHN MEZZALINGUA ASSOCIATES, INC., East Syracuse, NY (US)

(21) Appl. No.: 13/171,523

(22) Filed: Jun. 29, 2011

(51) Int. Cl. H01B 9/02; H01B 5/00

(52) U.S. Cl. 174/106 R; 174/126.2

(57) ABSTRACT

A center conductor for a cable is provided, the center conductor includes: an interior portion comprising steel and an exterior portion formed over the interior portion. The exterior portion includes at least one layer comprising a metallic material differing from the steel interior portion. The exterior portion is configured to design specific signal loss characteristics, at various operating frequencies, of a signal flowing through the exterior portion.

### BACKGROUND OF THE INVENTION

1. Technical Field

The present invention relates to center conductors and, more particularly, a method for designing a cable with specific attenuation characteristics.

2. Related Art

Conductive cables are useful for a variety of purposes, including propagating a signal. Various cable materials may result in signal loss of the signal flowing through the cable. Signal loss may cause a terminating device to malfunction. Accordingly, there exists a need in the art to overcome at least some of the deficiencies and limitations described herein above.

### SUMMARY OF THE INVENTION

The present invention provides an apparatus for use with signal cable conductors that offer improved reliability.

A first object of the present invention provides center conductor for a cable comprising: an interior portion comprising a material selected from the group consisting of steel and aluminum; and an exterior portion formed over the interior portion, wherein the exterior portion comprises at least one layer comprising a metallic material differing from the material of the interior portion, and wherein the exterior portion is configured to design specific signal loss characteristics, at various operating frequencies, of a signal flowing through the exterior portion.

A second object of the present invention provides a method of forming a center conductor of a cable, comprising the steps of: determining a specific signal loss characteristic for the cable; forming an interior portion of the center conductor, wherein the center conductor comprises steel; and forming an exterior portion of the center conductor over the interior portion, wherein the exterior portion comprises at least one layer comprising a metallic material associated with the specific signal loss characteristic for a signal to flow through the exterior portion, and wherein the metallic material differs from the steel.

A third object of the present invention provides a system comprising: an apparatus configured to generate an RF signal; a cable comprising; a center conductor comprising an interior portion comprising steel; and an exterior portion formed over the interior portion, wherein the exterior portion comprises at least one layer comprising a metallic material differing from said steel, and wherein the exterior portion is configured to modify signal loss characteristics of a signal flowing through the exterior portion; a dielectric formed over and surrounding the exterior portion; a shielding layer formed over and surrounding the dielectric; and an insulative jacket formed over and surrounding the shielding layer; and a connector connecting the cable to the head-end apparatus.

The foregoing and other features of the invention will be apparent from the following more particular description of various embodiments of the invention.

### DESCRIPTION OF THE DRAWINGS

The present invention will be more fully understood and appreciated by reading the following Detailed Description in conjunction with the accompanying drawings, in which:

FIG. 1 is a cross-sectional perspective view of a center conductor, in accordance with embodiments of the present invention.

FIGS. 2-5 illustrate cross-sectional perspective views of various embodiments of a cable, in accordance with embodiments of the present invention.

FIG. 6 illustrates a method for forming the cables of FIGS. 2-5, in accordance with embodiments of the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., which are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

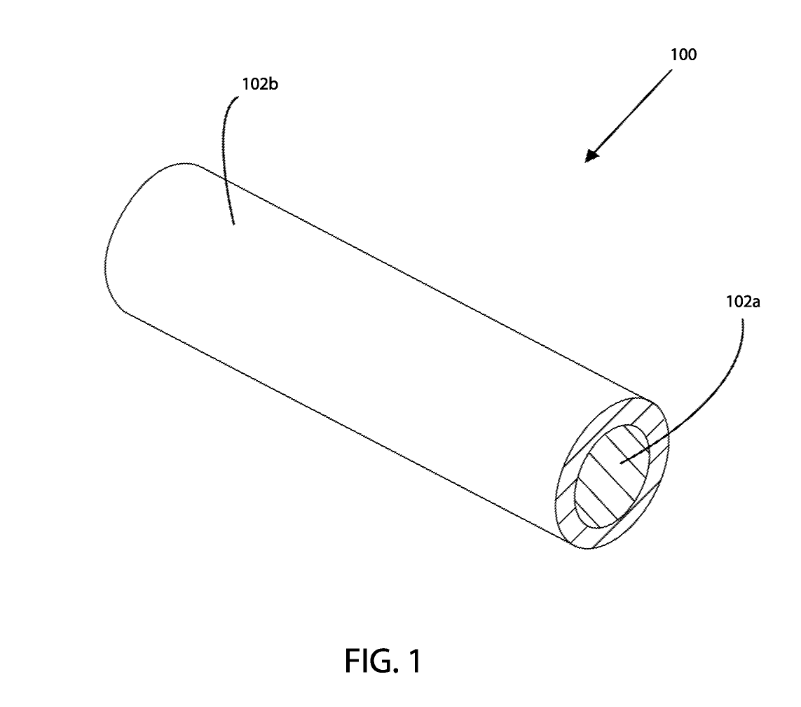

Referring now to the drawings, wherein like reference numerals refer to like parts throughout, there is seen in FIG. 1 a cross-sectional perspective view of a center conductor 100, in accordance with embodiments of the present invention. The center conductor 100 is a multilayered center conductor comprised by a cable (e.g., a coaxial cable). The center conductor 100 is configured to propagate a (communications) signal between two or more points. The center conductor 100 includes an inner layer 102a and an outer layer(s) 102b (i.e., an outer skin) plated, clad, or deposited (e.g., using a sputtering process) over the inner layer 102a. The inner layer 102a is formed from a conductive material such as, among other things, steel, copper, aluminum, etc. The outer layer 102b is formed from a conductive material (differing from the inner layer 102a) such as, among other things, gold, tin, copper, silver etc. A signal (e.g., an alternating current signal) flowing through center conductor 100 typically flows through the outer layer 102b (i.e., skin effect) or a portion of the outer layer 102b. The signal flowing through the outer layer 102b may result in signal loss of the signal depending on a material(s) of the outer layer 102b and a frequency of the signal. For example (in copper), at 5 MHz, a signal loss may be 0.58 dB per 100 feet. Various configurations of conductor 100 (e.g., multiple layers comprising different materials, thicknesses of outer layers, etc) allow for designing signal loss (i.e., attenuation) characteristics, at different operating frequencies, of the center conductor 100 to modify a signal loss of the signal flowing through the center conductor 100. Therefore, a cable may be designed to incorporate specific signal loss (i.e., attenuation) characteristics at different operating frequencies. A skin depth δₛ for the outer layer 102b is defined herein as a depth below a surface of a conductor (e.g., outer layer 102b) where a current density decays to about ⅓ of a current density of a conductor surface. Skin depth δₛ is calculated by the following equation 1:

δₛ=(1/(π×f×μ×σ))^{1/2} Equation 1

In equation 1: f=a frequency of a signal flowing through center conductor 100, μ=a permeability of a material of center conductor 100, and μ=a conductivity of the material. Using equation 1 to generate the following table 1 illustrates that a lower conductivity for a material results in a lower skin depth for the material and as a permeability of a material decreases, a skin depth increases. Therefore, as frequency, permeability, and conductivity increases, a skin depth of a material decreases.

| | | | Skin Depth (δ) |
|---|---|---|---|
| Material | Permeability (μ) | Conductivity (σ) | inches @ 5 MHz |
| Steel | 875 × 10⁻⁶ | 0.60 × 10⁷ | 0.000137 |
| Aluminum | 1.257 × 10⁻⁶ | 3.82 × 10⁷ | 0.001434 |
| Copper | 1.257 × 10⁻⁶ | 5.80 × 10⁷ | 0.00116 |

Therefore, by configuring the outer layer 102b of the center conductor 100 to include multiple layers comprising different materials and thicknesses, allows for designing cables (e.g., coaxial cables) comprising specific signal loss (i.e., attenuation) characteristics at different operating frequencies.

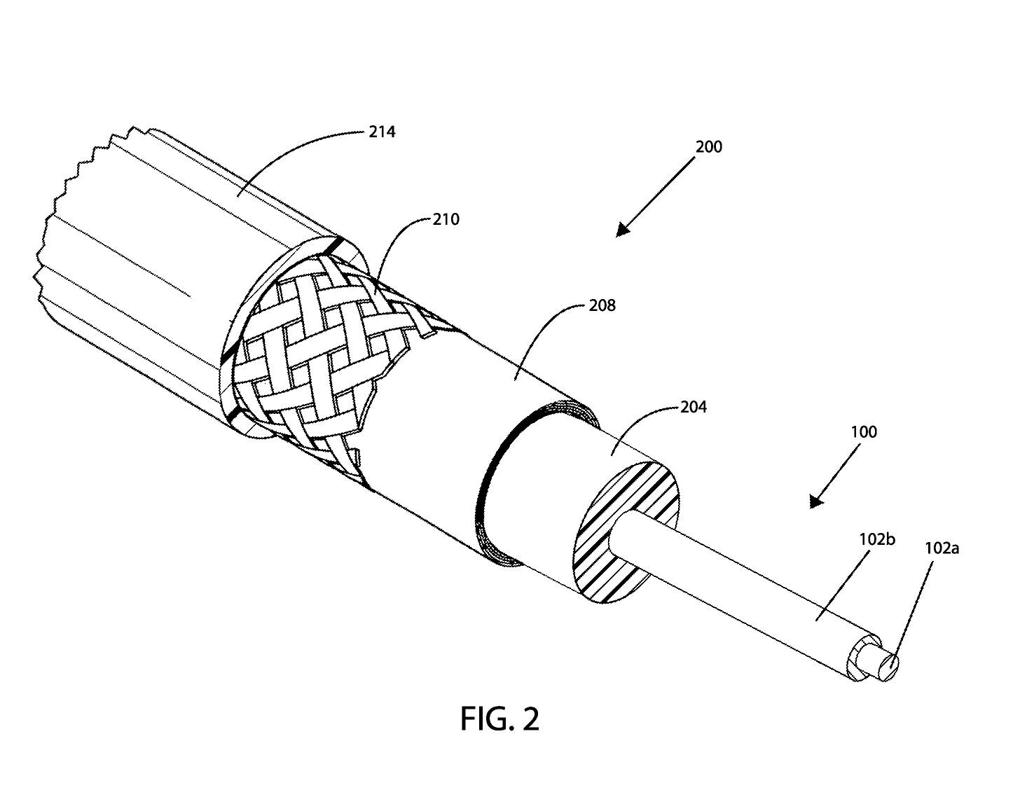

With continued reference to the drawings, FIG. 2 illustrates a cross-sectional perspective view of a cable 200, in accordance with embodiments of the present invention. The cable 200 includes the multilayered center conductor 100 (of FIG. 1), an insulator layer 204 formed over outer layer 102b, a conductive tape layer 208 formed over the insulator layer 204, a conductive braid layer 210 formed over the conductive tape layer 208, and an insulative jacket 214 formed over the conductive braid layer. Although FIG. 2 illustrates cable 200 as a coaxial cable (e.g., 50 ohm, 75 ohm, etc), note that cable 200 may comprise any type of cable including, among other things, an HDMI cable, an Ethernet cable, a USB cable, etc. The center conductor 100 is positioned at the core of cable 200. The center conductor 100 is configured to carry (i.e., in the outer layer 102b) a range of electrical current (e.g., amperes) as well as an R/F/electronic digital signal. The insulator layer 204 surrounds the center conductor 100 and generally serves to support and insulate the center conductor 100. Although not shown in the figures, a bonding agent, such as an insulating or semi-conducting polymer, may be employed to bond the insulator layer 204 to the center conductor 100. In some example embodiments, the insulator layer 204 may be, but is not limited to, taped, solid, or foamed polymer or fluoropolymer. For example, the insulator layer 204 may be foamed polyethylene (PE). The conductive tape layer 208 surrounds the insulator layer 204 and generally serves as a shielding layer to minimize the ingress and egress of high frequency electromagnetic fields to/from the center conductor 100. The conductive tape layer 208 may comprise a laminate tape that includes, among other things, a multiple aluminum layers, a polymer layer, and a polymer bonding agent layer. The conductive braid layer 210 surrounds the conductive tape layer 208 and generally serves as an additional shielding layer (i.e., in addition to conductive tape layer 208) to minimize the ingress and egress of high frequency electromagnetic fields to/from the center conductor 100. The conductive braid layer 210 may be formed, for example, from inter-woven, fine gauge aluminum or copper wires, such as 34 American wire gauge (AWG) wires. Although the braid wires of the conductive braid layer 210 are depicted as single rectangular wires in FIG. 2, each rectangular wire actually represents several round 34 AWG wires. It is understood, however, that the discussion herein of braid is not limited to braid formed from any particular type, size, and/or of wire and/or number of wires. The insulative jacket 214 surrounds the conductive braid layer 210 and generally serves to protect the internal components (e.g., center conductor 100, conductive tape layer 208, conductive braid layer 210, etc) of the cable 100 from external contaminants, such as dust, moisture, and oils, as well as wear and tear over time, for example. The insulative jacket 214 may be formed from materials such as, but not limited to, polyethylene (PE), high-density polyethylene (HDPE), low-density polyethylene (LDPE), or linear low-density polyethylene (LLDPE), foamed PE, polyvinyl chloride (PVC), or polyurethane (PU), or some combination thereof.

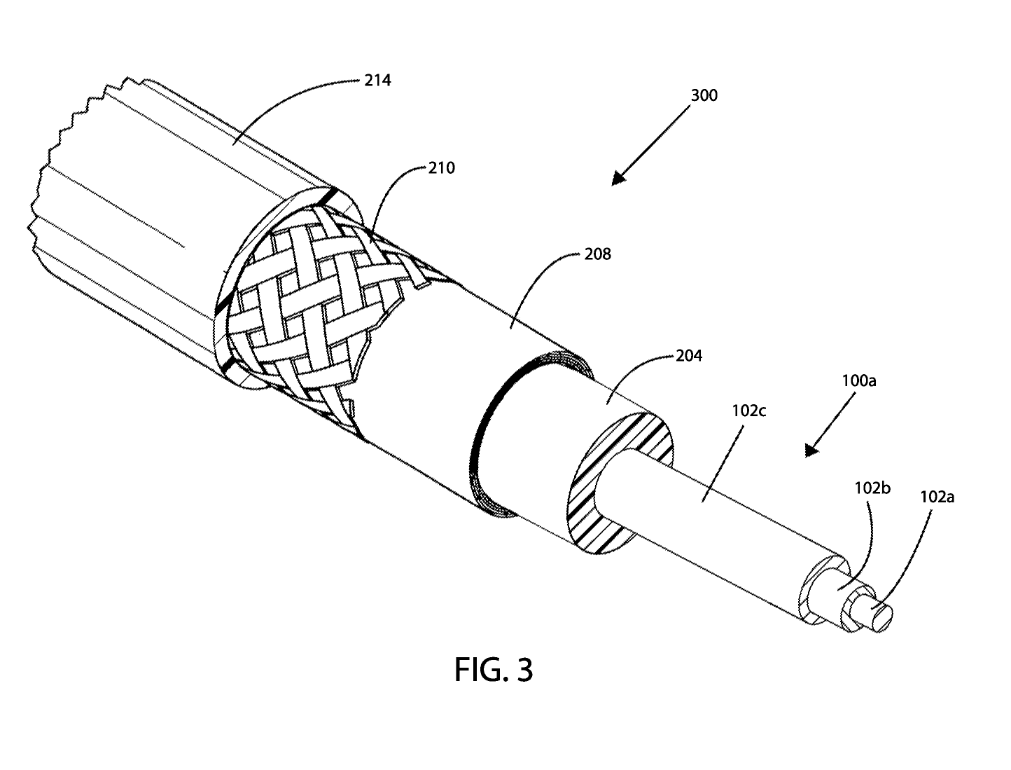

With continued reference to the drawings, FIG. 3 illustrates a cross-sectional perspective view of an alternative cable 300 (to cable 200 of FIG. 2), in accordance with embodiments of the present invention. In contrast to cable 200 of FIG. 2, cable 300 of FIG. 3 includes an alternative center conductor 100a comprising an additional conductive outer layer 102c (i.e., an outer skin) plated, clad, or deposited (e.g., using a sputtering process) over the outer layer 102b. The outer layer 102c is formed from a conductive material (differing from the outer layer 102b) such as, among other things, gold, tin, copper, silver etc. A signal (e.g., an alternating current signal) flowing through center conductor 100a will flow through the outer layers 102b and 102c (i.e., skin effect). Different portions of the signal will flow through the different outer layers 102b and 102c depending on a frequency of each portion of the signal thereby allowing for a flattening of the specific signal loss (i.e., attenuation) characteristics.

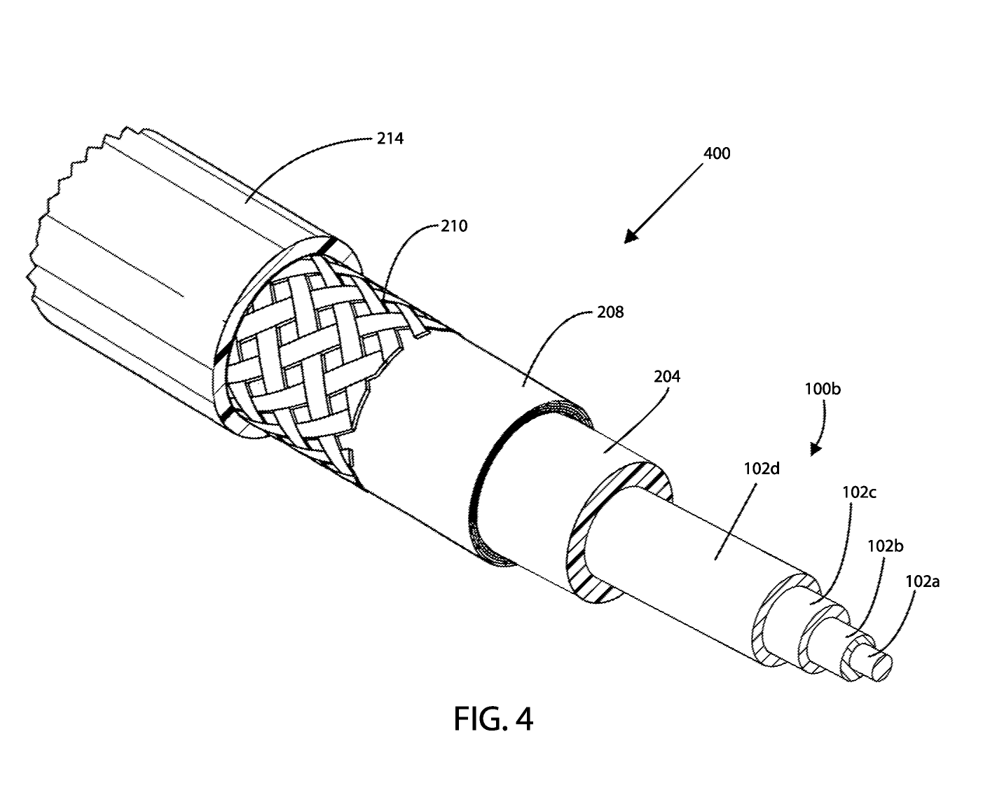

With continued reference to the drawings, FIG. 4 illustrates a cross-sectional perspective view of an alternative cable 400 (to cable 300 of FIG. 3), in accordance with embodiments of the present invention. In contrast to cable 300 of FIG. 3, cable 400 of FIG. 4 includes an alternative center conductor 100b comprising an additional conductive outer layer 102d (i.e., an outer skin) plated, clad, or deposited (e.g., using a sputtering process) over the outer layer 102c. The outer layer 102d is formed from a conductive material (differing from the outer layers 102b and 102c) such as, among other things, gold, tin, copper, silver etc. A signal (e.g., an alternating current signal) flowing through center conductor 100b will flow through the outer layers 102b, 102c, and 102d (i.e., skin effect). Different portions of the signal will flow through the different outer layers 102b, 102c, and 102d depending on a frequency of each portion of the signal thereby allowing for a flattening of the specific signal loss (i.e., attenuation) characteristics.

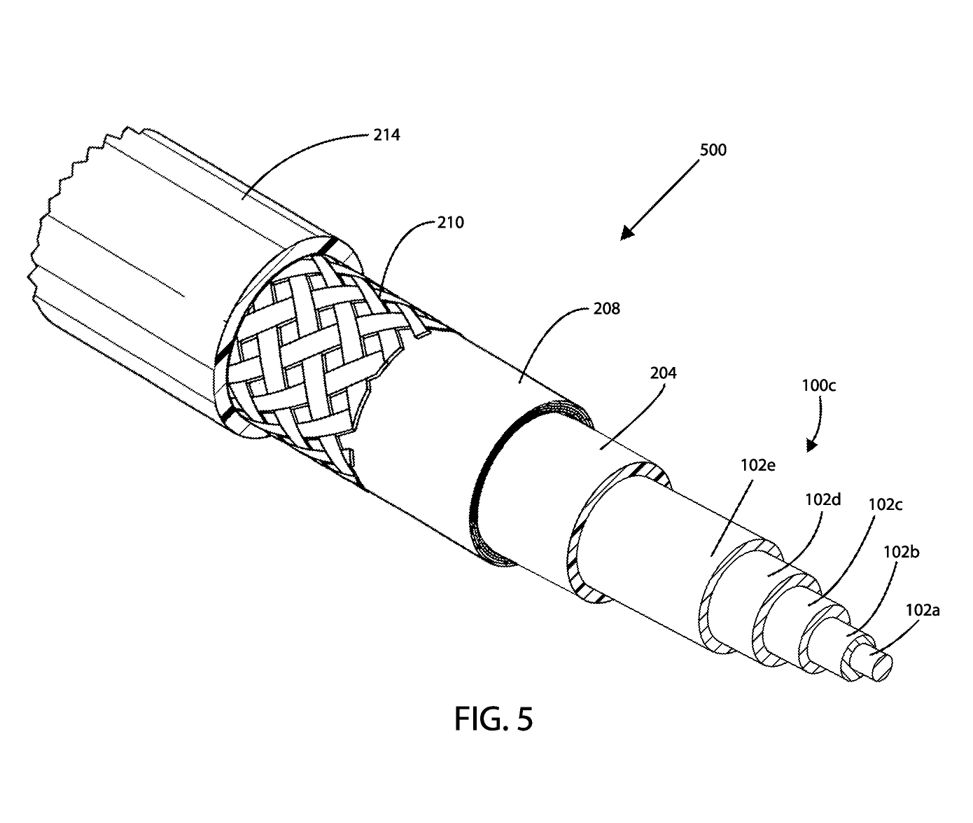

With continued reference to the drawings, FIG. 5 illustrates a cross-sectional perspective view of an alternative cable 500 (to cable 400 of FIG. 4), in accordance with embodiments of the present invention. In contrast to cable 400 of FIG. 4, cable 500 of FIG. 5 includes an alternative center conductor 100c comprising an additional conductive outer layer 102e (i.e., an outer skin) plated, clad, or deposited (e.g., using a sputtering process) over the outer layer 102d. The outer layer 102e is formed from a conductive material (differing from the outer layers 102b, 102c, and 102d) such as, among other things, gold, tin, copper, silver etc. A signal (e.g., an alternating current signal) flowing through center conductor 100c will flow through the outer layers 102b, 102c, 102d, and 102e (i.e., skin effect). Different portions of the signal will flow through the different outer layers 102b, 102c, 102d, and 102e depending on a frequency of each portion of the signal thereby allowing for a flattening of the specific signal loss (i.e., attenuation) characteristics.

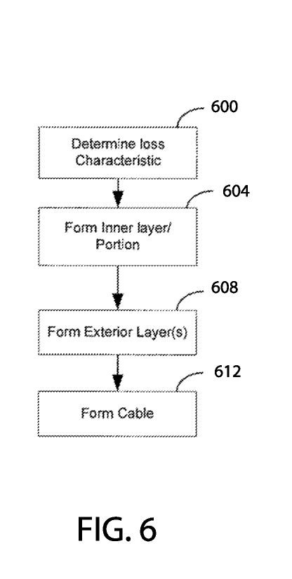

With continued reference to the drawings, FIG. 6 illustrates a method for forming the cables of FIGS. 2-5, in accordance with embodiments of the present invention. In step 600, a specific signal loss (i.e., attenuation) characteristic, at different operating frequencies, of a signal is determined for a specific cable design. In step 604, an inner layer/portion (e.g., inner layer 102a in FIGS. 2-5) of a center conductor (e.g., center conductors 100-100c of FIGS. 2-5) is formed. In step 608, an outer layer(s) (e.g., layers 102b-102e of FIGS. 2-5) is/are formed (e.g., by plating, cladding, depositing, etc) over the inner layer/portion of the center conductor. The outer layer(s) each include a different metallic material associated with the specific signal loss characteristic determined in step 600. In step 612, the cable is formed. For example, the insulator layer 204, the conductive tape layer 208, the conductive braid layer 210, and the insulative jacket of FIGS. 2-5.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

What is claimed is:

1. A center conductor for a cable comprising:
an interior portion comprising a material selected from the group consisting of steel and aluminum; and
an exterior portion formed over the interior portion, wherein the exterior portion comprises at least one layer comprising a metallic material differing from the material of the interior portion, and wherein the exterior portion is configured to design specific signal loss characteristics, at various operating frequencies, of a signal flowing through the exterior portion.

2. The cable of claim 1, wherein the exterior portion comprises a first layer plated, clad, or deposited over and in contact with the interior portion, and wherein the first layer comprises a first metallic material selected from the group consisting of gold, tin, copper, and silver.

3. The cable of claim 2, wherein the exterior portion comprises a second layer plated, clad, or deposited over and in contact with the first layer, wherein the second layer comprises a second metallic material selected from the group consisting of gold, tin, copper, and silver, and wherein the first metallic material differs from the second metallic material.

4. The cable of claim 3, wherein the exterior portion comprises a third layer plated, clad, or deposited over and in contact with the second layer, wherein the third layer comprises a third metallic material selected from the group consisting of gold, tin, copper, and silver, and wherein the third metallic material differs from the first metallic material and the second metallic material.

5. The cable of claim 4, wherein the exterior portion comprises a fourth layer plated, clad, or deposited over and in contact with the third layer, wherein the fourth layer comprises a fourth metallic material selected from the group consisting of gold, tin, copper, and silver, and wherein the fourth metallic material differs from the first metallic material, the second metallic material, and the third metallic material.

6. The cable of claim 5, wherein the first layer comprises tin, wherein the second layer comprises copper, wherein the third layer comprises silver, and wherein the fourth layer comprises gold.

7. The cable of claim 5, wherein the first layer comprises gold, wherein the second layer comprises silver, wherein the third layer comprises copper, and wherein the fourth layer comprises tin.

8. The cable of claim 5, wherein the exterior portion is configured to modify flat loss characteristics of the signal flowing through the exterior portion.

9. The cable of claim 1, wherein the exterior portion is graded such that the exterior portion comprises a plurality of thicknesses in different locations over the interior portion.

10. The cable of claim 1, further comprising:
a bonding agent formed over and in contact with the exterior portion
a dielectric formed over and surrounding the bonding agent;
a first shielding layer formed over and surrounding the dielectric;
a second shielding layer formed over and surrounding the first shielding layer; and
an insulative jacket formed over and surrounding the second shielding layer.

11. The cable of claim 10, wherein the first shielding layer comprises a conductive tape layer and wherein the second first shielding layer comprises a conductive braid layer.

12. A method of forming a center conductor of a cable, comprising the steps of:
determining specific signal loss characteristics, at various operating frequencies, for the cable;
forming an interior portion of the center conductor, wherein the interior portion comprises a material selected from the group consisting of steel and aluminum; and
forming an exterior portion of the center conductor over the interior portion, wherein the exterior portion comprises at least one layer comprising a metallic material associated with the specific signal loss characteristics for a signal to flow through the exterior portion, and wherein the metallic material differs from the material of the interior portion.

13. The method of claim 12, wherein the forming the exterior portion comprises:
plating, cladding, or depositing a first layer over and in contact with the interior portion, wherein the first layer comprises a first metallic material selected from the group consisting of gold, tin, copper, and silver.

14. The method of claim 13, wherein the forming the exterior portion further comprises:
plating, cladding, or depositing a second layer over and in contact with the first layer, wherein the second layer comprises a second metallic material selected from the group consisting of gold, tin, copper, and silver, and wherein the first metallic material differs from the second metallic material.

15. The method of claim 14, wherein the forming the exterior portion further comprises:
plating, cladding, or depositing a third layer over and in contact with the second layer, wherein the third layer comprises a third metallic material selected from the group consisting of gold, tin, copper, and silver, and wherein the third metallic material differs from the first metallic material and the second metallic material.

16. The method of claim 15, wherein the forming the exterior portion further comprises:
plating, cladding, or depositing a fourth layer over and in contact with the third layer, wherein the fourth layer comprises a fourth metallic material selected from the group consisting of gold, tin, copper, and silver, and wherein the fourth metallic material differs from the first metallic material, the second metallic material, and the third metallic material.

17. The method of claim 16, wherein the first layer comprises tin, wherein the second layer comprises copper, wherein the third layer comprises silver, and wherein the fourth layer comprises gold.

18. The method of claim 16, wherein the first layer comprises gold, wherein the second layer comprises silver, wherein the third layer comprises copper, and wherein the fourth layer comprises tin.

19. The method of claim 12, wherein the exterior portion is graded such that the exterior portion comprises a plurality of thicknesses in different locations over the interior portion.

20. A system comprising:
an apparatus configured to generate an RF signal;
a cable comprising;
a center conductor comprising an interior portion comprising steel; and
an exterior portion formed over the interior portion, wherein the exterior portion comprises at least one layer comprising a metallic material differing from the steel, and wherein the exterior portion is configured to design specific signal loss characteristics, at various operating frequencies, of a signal flowing through the exterior portion;
a dielectric formed over and surrounding the exterior portion;
a shielding layer formed over and surrounding the dielectric; and
an insulative jacket formed over and surrounding the shielding layer; and
a connector connecting the cable to the apparatus.
